(19) United States
(12) Patent Application Publication
(10) Pub. No.: US 2026/0280402 A1
(43) Pub. Date: Sep. 17, 2026

(54) POWER PROVISION DEVICE AND METHOD THEREOF

(71) Applicant: Renesas Design (UK) Limited, Bourne End (GB)

(72) Inventors: Mark Jonathan CHILDS, Cirencester (GB); Davide BIANCHI, Swindon (GB); Julian TYRRELL, Swindon (GB)

(73) Assignee: Renesas Design (UK) Limited, Bourne End (GB)

(21) Appl. No.: 19/080,245

(22) Filed: Mar. 14, 2025

(51) Int. Cl. H02M 1/00; G06F 1/26

(52) U.S. Cl. CPC H02M 1/0003; G06F 1/26; H02M 1/0083

(57) ABSTRACT

A power provision device including: a load element; a power supply plane configured to provide current to the load element; a plurality of power supply elements configured to provide current to the power supply plane; wherein each power supply element of the plurality of power supply elements is configured to supply a current to the power supply plane via an individual power connection; wherein each power supply element comprises a voltage feedback connection between the power supply element and the power supply plane; and wherein each voltage feedback connection is configured to provide a feedback signal from the power supply plane to the corresponding power supply element, the feedback signal indicating a supplied voltage.

The present disclosure relates to a power provision device.

### BACKGROUND

Advancements in the field of processor chips have led to processors such as CPUs and GPUs becoming larger and more powerful, and therefore requiring more current input and higher powered supplies which, in turn, leads to larger processor chips which draw very high currents.

Additionally, chips designed for use in AI applications can be very large and can draw currents over 1000 A. These chips are not typically divided into cores, and thus the high current must be provided as a single rail. An example of such a chip is shown in FIG. 1. This may require a very high number of IVR phases (for example, over 100), for which conventional control is unsuitable because the control signal from the central controller of the chip must be fanned out to every phase causing a routing problem.

Lately, a change made to multi-core architectures is that a dedicated IVR connected to each load element has been replaced by connecting all power supplies in parallel to a single power supply plane. Further, load elements are not segregated; instead, there is provided a single load with connections to the power plane at various locations (thus, it might be considered a single load with multiple load demand “zones”).

As shown in FIG. 1, load demand on the power plane varies widely during operation, meaning that load current variations being drawn from different physical locations of the power plane dynamically changes throughout the system operation. Additionally, load is not necessarily evenly distributed across the power plane. This means that when using a realistic power plane with finite impedance, uneven load distribution causes current flows along the plane and voltage drops across the area of distributed load.

For a conventional controller this will be an issue because a conventional controller has only a single point where a feedback signal is taken. If the feedback signal is not sampled at the place with the highest voltage drop, then the regulated voltage at this point may be below the minimum target voltage. Additionally, the problem is compounded by load current variations being drawn from different physical locations of the power plane dynamically changing throughout system operation, creating significant variation in voltage across the power plane.

### SUMMARY

According to a first aspect of the disclosure, there is provided a power provision device comprising:
a load element;
a power supply plane configured to provide current to the load element;
a plurality of power supply elements configured to provide current to the power supply plane;
wherein each power supply element of the plurality of power supply elements is configured to supply a current to the power supply plane via an individual power connection;
wherein each power supply element comprises a voltage feedback connection between the power supply element and the power supply plane; and
wherein each voltage feedback connection is configured to provide a feedback signal from the power supply plane to the corresponding power supply element, the feedback signal indicating a supplied voltage.

Optionally, wherein the power supply plane comprises a first surface facing the load element and a second surface facing the plurality of power supply elements;
wherein the plurality of power supply elements are connected in parallel through the power supply plane to the load element; and
wherein the voltage feedback connection of each power supply element is connected to the load element.

Optionally, wherein each power supply element comprises a controller configured to:
compare the voltage feedback signal received from the voltage feedback connection with a predetermined target output voltage to determine if the predetermined target output voltage is being supplied; and
adjust the current supplied by the power supply element if it is determined that the predetermined target output voltage is not being supplied.

Optionally, wherein each power supply element of the plurality of power supply elements is controlled individually and independently from each other power supply element.

Optionally, wherein the plurality of power supply elements are grouped into a plurality of groups; and
wherein each group of the plurality comprises a voltage feedback connection between the power supply element and the power supply plane.

Optionally, wherein the feedback signal represents an output current supplied by the power supply element served by the corresponding voltage feedback connection at a point of supply on the power supply plane.

Optionally, wherein each voltage feedback connection is connected between the power supply element and the load element.

Optionally, wherein each power supply element of the plurality of power supply elements performs as a current source and is configured to provide a current corresponding to a selected current value.

Optionally, wherein the selected current value is one of a plurality of selectable current values.

Optionally, wherein the plurality of selectable current values include at least one value selected to provide a maximum efficiency and at least one value selected to provide a maximum current output.

Optionally, wherein the selected current value for each power supply element is selected based on a comparison between the voltage feedback signal and a predetermined target output voltage.

Optionally, wherein the provided current is linearly controlled proportional to the comparison between the voltage feedback signal and the predetermined target output voltage.

Optionally, wherein the power supply plane is a non-ideal resistive plane.

Optionally, wherein the power supply plane is made of copper.

Optionally, wherein the power supply elements of the plurality of power supply elements are power converters.

Optionally, wherein the power supply elements of the plurality of power supply elements are multi-phase buck converters.

According to a second aspect of the disclosure, there is provided a method of providing decentralized control for a processor device, the method comprising:
providing a load element;
providing a power supply plane configured to provide current to the load element;
providing a plurality of power supply elements configured to provide current to the power supply plane;
supplying current to the power supply plane from each power supply element via an individual power connection;
providing a voltage feedback connection between each power supply element of the plurality of power supply elements and the power supply plane; and
providing a voltage feedback signal via the voltage feedback connection to a corresponding power supply element from the power supply plane, the feedback signal indicating a supplied voltage.

Optionally, further comprising:
comparing the voltage feedback signal received from the voltage feedback connection with a predetermined target output voltage to determine if the predetermined target output voltage is being supplied; and
adjusting the current supplied by the power supply element if it is determined that the predetermined target input voltage is not being supplied.

### BRIEF DESCRIPTION OF THE DRAWINGS

The disclosure is described in further detail below by way of example and with reference to the accompanying drawings, in which:

FIG. 1 is an exploded diagram of an example of a power provision device according to the prior art;

FIG. 2 is a block diagram of a power provision device according to the present disclosure;

FIG. 3 is a block diagram showing connections within a power provision device according to the present disclosure;

FIG. 4 is an exploded diagram of a power provision device according to the present disclosure;

FIG. 5 is a flowchart showing a method of operation of a power provision device according to the present disclosure; and

FIG. 6A is a graph illustrating output voltage across a power provision device according to the prior art; and FIG. 6B is a graph illustrating output voltage across a power provision device according to the present disclosure.

### DETAILED DESCRIPTION

The current disclosure relates to a power provision device with distributed control.

FIG. 2 is a block diagram representing a power provision device 200 according to the present disclosure. The power provision device 200 comprises a load element 210, a power supply plane 220 configured to provide current to the load element; and a plurality of power supply elements 230a-230i configured to provide current to the power supply plane 220.

The load element 210 may be a processor core, such as a CPU or GPU core. Although one load element is shown, it should be understood that a power provision device according to the present disclosure may include more than one load element.

The plurality of power supply elements 230a-230i may be power converters. The plurality of power supply elements 230a-230i may be multi-phase buck converters. The plurality of power supply elements 230a-230i may also be referred to as “phases”.

The power supply plane 220 may be a non-ideal resistive plane. The power supply plane 220 may be made of a conductive material. For example, the power supply plane 220 may be made of copper. Alternatively, the power supply plane 220 may be an ideal plane with zero impedance.

The power supply plane 220 acts as a voltage rail, providing voltage to the load element (or load elements, in some examples). In addition to the power supply plane 220, a further plane (not shown) may be provided which acts as a ground rail.

Although nine power supply elements 230a-230i are shown, it should be understood that the power provision device 300 may comprise more or fewer than nine power supply elements.

Connections between the plurality of power supply elements 230a-230i and the power supply plane 220 are shown by the solid, dotted, and dashed lines. A connection between the power supply plane 220 and the load element 210 is also shown. It should be understood that the connections shown are merely illustrative, and may be configured differently.

The plurality of power supply elements 230a-230i are connected in parallel to the power supply plane 220. Each of the plurality of power supply elements 230a-230i are configured to supply a voltage to the power supply plane 220 via an individual power connection. That is, each power supply element of the plurality of power supply elements 230a-230i is individually connected to the power supply plane 220.

Additionally, each of the plurality of power supply elements 230a-230i comprises a voltage feedback connection between the power supply element and the power supply plane 220. That is, each power supply element has a voltage feedback connection with the power supply plane 220 allowing each power supply element to both supply voltage to the power supply plane 220 via a power connection and also receive feedback on the supplied voltage via the voltage feedback connection. Thus, each power supply element 230a-230i is able to regulate its own current supply to the power supply plane 220.

The connections (both power connections and voltage feedback connections) may be wired connections, or any other suitable connection.

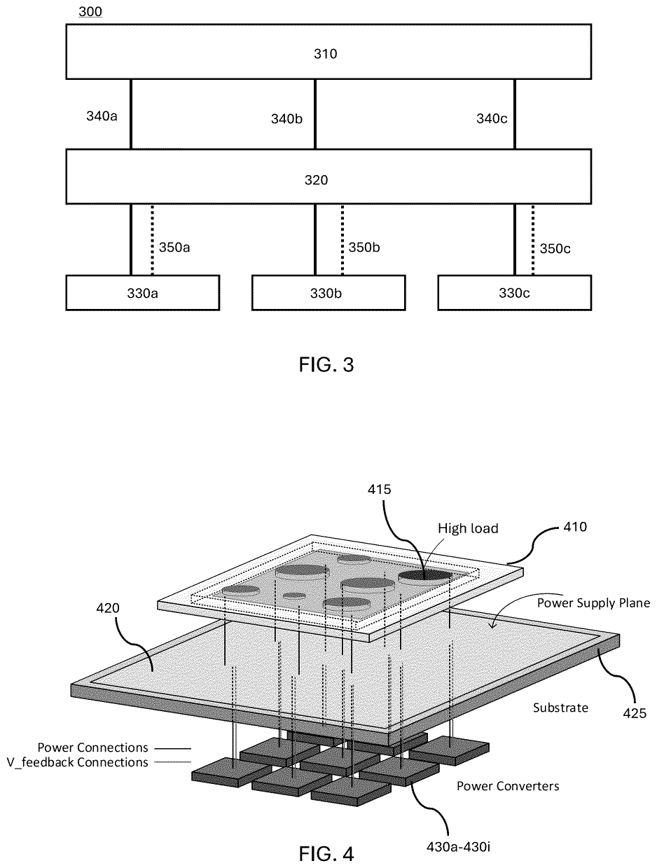

FIG. 3 is a block diagram illustrating a layered structure of the power provision device 300. The power provision device 300 may be the same as the power provision device 200 as illustrated by FIG. 2.

The power provision device 300 includes a plurality of power supply elements 330a, 330b, 330c, a power supply plane 320, and a load elements 310.

The plurality of power supply elements 330a, 330b, 330c may be disposed as a plane. Although three power supply elements 330a, 330b, 330c are shown, it should be understood that the power provision device 300 may comprise more or fewer than three power supply elements.

As shown, a load element 310 is disposed as a top layer of the power provision device 300. The plurality of power supply elements 330a, 330b, 330c may be disposed as a bottom layer of the power provision device 300. Alternatively, a ground plane (a conductive plane serving as a ground rail) may be disposed as a bottom layer of the power provision device 300 such that the plurality of power supply elements 330a, 330b, 330c are disposed on top of the ground plane.

Sandwiched between the load element 310 and the plurality of power supply elements 330a, 330b, 330c is a power supply plane 320. That is, an upper surface of the supply plane 320 faces a lower surface of the load element 310. A lower surface of the supply plane 320 faces an upper surface of the plurality of power supply elements 330a, 330b, 330c.

It should be noted that there may be other layers disposed between the layers described above which are not related to the function of the claimed device.

The power supply plane 320 may be mounted on a substrate (not shown).

The power supply plane may comprise holes or openings (not shown) to accommodate ground connections (that is, connections to a ground plane).

The plurality of power supply elements 330a, 330b, 330c may be connected in parallel through the power supply plane to the load element.

Each of the plurality of power supply elements 330a, 330b, 330c is connected to the power supply plane by a voltage feedback connection which is configured to provide feedback (for example, by transmitting a feedback signal from the power supply plane to the power supply element) representing the current supplied by the power supply element.

Alternatively, the plurality of power supply elements 330a, 330b, 330c may be connected to the load element by a voltage feedback connection which is configured to provide feedback representing the current supplied by the power supply element. That is, the voltage feedback connections may be connected between the plurality of power supply elements 330a, 330b, 330c and either the power supply plane or the load element.

In more detail, each of the plurality of power supply elements 330a, 330b, 330c may comprise a controller. The controller of each of the plurality of power supply elements 330a, 330b, 330c may be configured to compare (for example, by the use of a comparator device or any other suitable method) a voltage feedback signal received via (or from) the voltage feedback connection with a predetermined target output voltage to determine if the predetermined target output voltage is being supplied. If it is determined that the predetermined target output voltage is not being supplied by the power supply element, the current supplied by the power supply element may be adjusted.

The predetermined target output voltage may be set based on the requirements of the device. For example, the predetermined target output current may change throughout operation of the device, or may be set in advance of the operation of the device based on various factors related to the device and the application the device is being used in.

The voltage feedback signal may represent an output current supplied by the power supply element served by the corresponding voltage feedback connection at a point of supply on the power supply plane 320. For example, the power supply element 330a is served by voltage feedback connection 350a and thus receives a voltage feedback signal representing the output current supplied by the power supply element 330a from the voltage feedback connection 350a.

Each of the plurality of power supply elements 330a, 330b, 330c may perform as a current source and may be configured to provide a current corresponding to a selected current value. For example, each of the plurality of power supply elements 330a, 330b, 330c may be preconfigured to support the provision of a plurality of current values. That is, the selected current values may be one of a plurality of selectable current values.

The plurality of selectable current values may include at least one value selected to provide a maximum efficiency (that is, a current value that represents a smallest current value that can be provided to the device or system) and at least one value selected to provide a maximum current output (that is, a current value that represents a largest current value that can be provided to the device or system). In addition, there may be provided a number of current values existing between these two values; for example, the plurality of selectable current values may represent a plurality of steps between a largest and a smallest current value.

The selected current value for each power supply element of the plurality of power supply elements 330a, 330b, 330c may be selected based on the comparison between the voltage feedback signal and the predetermined target output voltage. The selected current value for each power supply element may be the same or different to the selected current value of each other power supply element based on the comparison carried out by each power supply element.

The provided current may be linearly controlled such that it is proportional to the comparison between the voltage feedback signal and the predetermined target output voltage.

Each of the plurality of power supply elements 330a, 330b, 330c may be controlled individually and independently from each other power supply element. Alternatively, the plurality of power supply elements 330a, 330b, 330c may be organised into groups, wherein each group shares a controller. Thus, decentralised control is maintained with fewer controllers. In this case, each group of power supply elements may have a corresponding power connection and voltage feedback connection to the power supply plane.

Thus, each power supply element of the plurality of power supply elements 330a, 330b, 330c is configured to regulate the current they each supply to the power supply plane 320, allowing decentralising control to be provided.

The voltage feedback connections 350a, 350b, 350c may be positioned physically close (or near to) the power connections 340a, 340b, 340c; for example, the wires for each of these connections may be spaced physically close together. This minimizes the impact of IR losses of the power supply plane.

FIG. 4 is an exploded view diagram of a power provision device 400 according to the present disclosure. The power provision device 400 may be the same device as the power provision devices 200 and 300 as illustrated by FIGS. 2 and 3.

The power provision device 400 comprises a load element 410, a power supply plane 420 which is mounted on a substrate 425, and a plurality of power supply elements 430a-430i. The plurality of power supply elements 430a-430i may be power converters; for example, they may specifically be multi-phase buck converters, or any other suitable power converter.

The power supply plane 420 may be a non-ideal resistive plane; for example, the power supply plane 420 may be made of copper, or any other suitable material. Alternatively, the power supply plane 420 may be an ideal plane with zero impedance.

Additionally, solid lines show power connections extending from each power supply element 430a-430i to the power supply plane 420 and from the power supply plane 420 to the load element 410; and dashed lines show voltage feedback connections extending from the power supply elements to the power supply plane 420.

Although not shown, the plurality of power supply elements 430a-430i may be connected to the load element 410 by a voltage feedback connection which is configured to provide feedback representing the current supplied by the power supply element. That is, the voltage feedback connections may be connected between the plurality of power supply elements 430a-430i and either the power supply plane 420 or the load element 410.

Circles of various sizes on the load element 410 represent load demands (or characteristics) and demonstrate that the load may be unevenly distributed across the surface area of the load element. For example, a large circle represented in black represents a high load 415 which may be a cause of voltage drop in that area of the load element. The different load demands require different voltage output from the plurality of power supply elements 430a-430i. The voltage output by each of the power supply elements 430a-430i corresponds to a load demand at a physical location on the load element 410, allowing the high load demand to be met where in a conventional, centrally controlled configuration the regulated voltage may not meet the demand (for example, if the high load demand was not positioned near the central point where the controller is positioned).

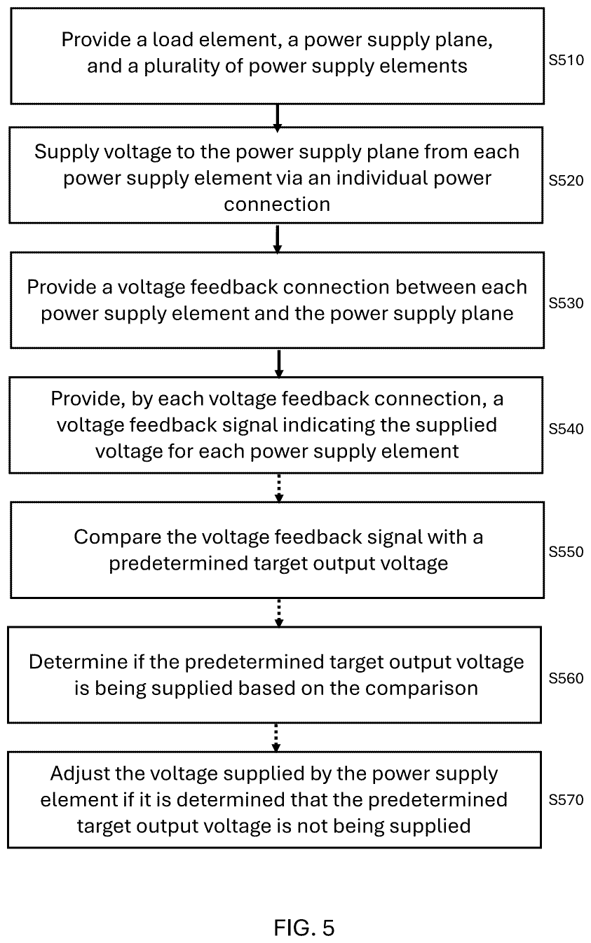

FIG. 5 is a flowchart illustrating a method of operating a power provision device such as the power provision devices illustrated in FIGS. 2, 3, and 4.

In step S510, a load element, a power supply plane, and a plurality of power supply elements are provided.

In step S520, current is supplied to the power supply plane from each power supply element via an individual power connection.

In step S530, a voltage feedback connection is provided between each power supply element and the power supply plane.

In step S540, each voltage feedback connection provides a voltage feedback signal, the voltage feedback signal indicating the supplied voltage for each power supply element.

Steps S550 to S570 represent optional steps which may be carried out.

In step S550, the voltage feedback signal received by each power supply element is compared with a predetermined target output voltage.

In step S560, it is determined, by a controller of each power supply element, if the predetermined target output voltage is being supplied, based on the comparison carried out in step S550.

In step S570, if it is determined that the predetermined target output voltage is not being supplied, the current supplied by the power supply element is adjusted.

That is, each power supply element carries out its own comparison of the voltage it is supplying to the power supply plane and determines whether the predetermined target output voltage. Then, each power supply element that determines that the predetermined target output voltage is not being met, the power supply element adjusts the supplied voltage to meet the predetermined target output voltage. The predetermined target output voltage may be different for each of the power supply elements.

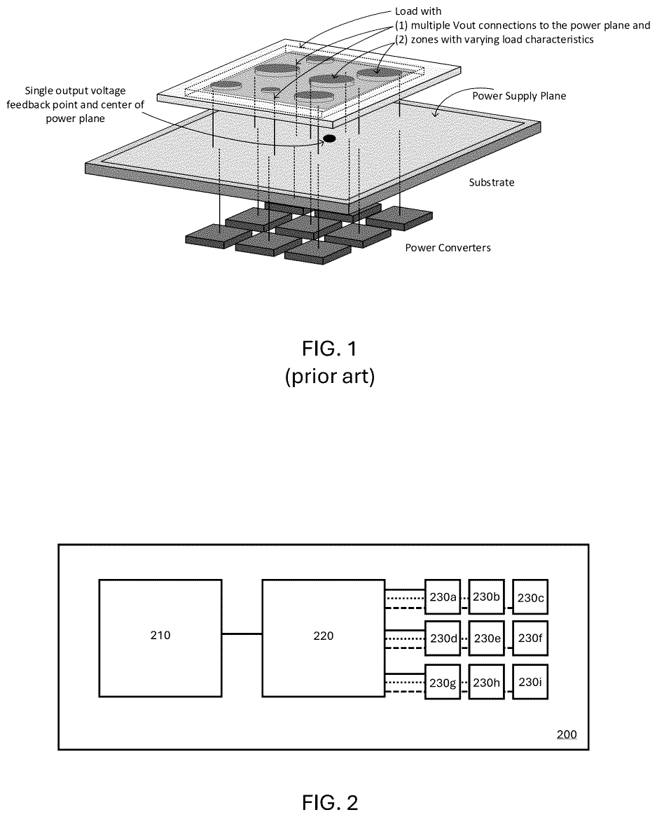

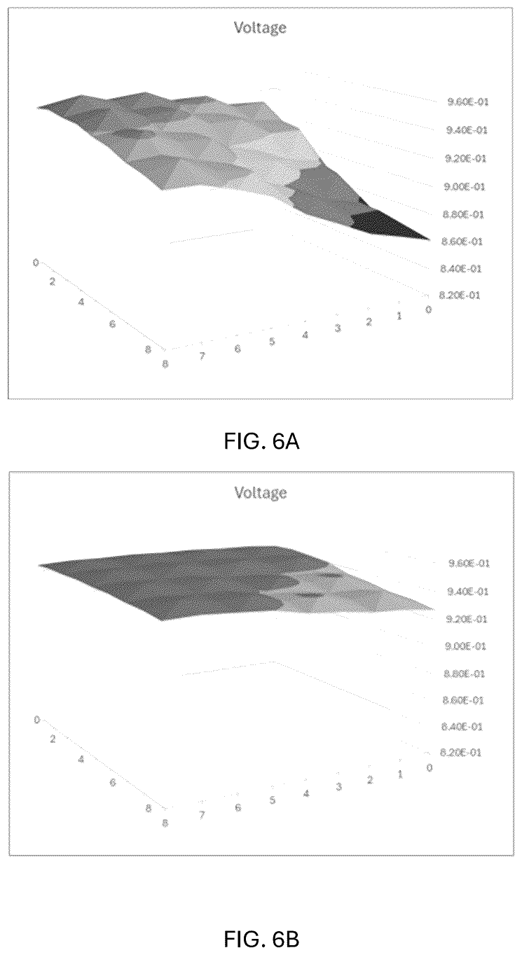

FIGS. 6A and 6B show a comparison between two graphs. FIG. 6A shows voltage across the load element in a conventional power provision device such as the device illustrated in FIG. 1. Unbalanced load conditions cause significant variation in voltage across the power supply plane, creating the very uneven Vout that can be seen in FIG. 6A.

In comparison, FIG. 6B shows voltage across the load element in a power provision device according to the present disclosure, for example any of the power provision devices show in FIGS. 2-4. Decentralised control provided by the individual voltage feedback connections across the power supply plane provide a reduced output voltage variance across the power supply plane despite any unbalanced load conditions. Thus, IR losses are minimised and the requirement to route a central control signal to every phase (power converter, or power supply element) is eliminated. Thus, layout is simplified and the amount of signals routing across the power domain is reduced.

Various improvements and modifications can be made to the above without departing from the scope of the disclosure.

1. A power provision device comprising:
a load element;
a power supply plane configured to provide current to the load element;
a plurality of power supply elements configured to provide current to the power supply plane;
wherein each power supply element of the plurality of power supply elements is configured to supply a current to the power supply plane via an individual power connection;
wherein each power supply element comprises a voltage feedback connection between the power supply element and the power supply plane; and
wherein each voltage feedback connection is configured to provide a feedback signal from the power supply plane to the corresponding power supply element, the feedback signal indicating a supplied voltage.

2. The power provision device of claim 1, wherein the power supply plane comprises a first surface facing the load element and a second surface facing the plurality of power supply elements;
wherein the plurality of power supply elements are connected in parallel through the power supply plane to the load element; and
wherein the voltage feedback connection of each power supply element is connected to the load element.

3. The power provision device of claim 2, wherein each power supply element comprises a controller configured to:
compare the voltage feedback signal received from the voltage feedback connection with a predetermined target output voltage to determine if the predetermined target output voltage is being supplied; and
adjust the current supplied by the power supply element if it is determined that the predetermined target output voltage is not being supplied.

4. The power provision device of claim 3, wherein each power supply element of the plurality of power supply elements is controlled individually and independently from each other power supply element.

5. The power provision device of claim 1, wherein the plurality of power supply elements are grouped into a plurality of groups; and
wherein each group of the plurality comprises a voltage feedback connection between the power supply element and the power supply plane.

6. The power provision device of claim 3, wherein the feedback signal represents an output current supplied by the power supply element served by the corresponding voltage feedback connection at a point of supply on the power supply plane.

7. The power provision device of claim 1, wherein each voltage feedback connection is connected between the power supply element and the load element.

8. The power provision device of claim 1, wherein each power supply element of the plurality of power supply elements performs as a current source and is configured to provide a current corresponding to a selected current value.

9. The power provision device of claim 8, wherein the selected current value is one of a plurality of selectable current values.

10. The power provision device of claim 9, wherein the plurality of selectable current values include at least one value selected to provide a maximum efficiency and at least one value selected to provide a maximum current output.

11. The power provision device of claim 9, wherein the selected current value for each power supply element is selected based on a comparison between the voltage feedback signal and a predetermined target output voltage.

12. The power provision device of claim 11, wherein the provided current is linearly controlled proportional to the comparison between the voltage feedback signal and the predetermined target output voltage.

13. The power provision device of claim 1, wherein the power supply plane is a non-ideal resistive plane.

14. The power provision device of claim 13, wherein the power supply plane is made of copper.

15. The processor device of claim 1, wherein the power supply elements of the plurality of power supply elements are power converters.

16. The power provision device of claim 15, wherein the power supply elements of the plurality of power supply elements are multi-phase buck converters.

17. A method of providing decentralized control for a processor device, the method comprising:
providing a load element;
providing a power supply plane configured to provide current to the load element;
providing a plurality of power supply elements configured to provide current to the power supply plane;
supplying current to the power supply plane from each power supply element via an individual power connection;
providing a voltage feedback connection between each power supply element of the plurality of power supply elements and the power supply plane; and
providing a voltage feedback signal via the voltage feedback connection to a corresponding power supply element from the power supply plane, the feedback signal indicating a supplied voltage.

18. The method of claim 17, further comprising:
comparing the voltage feedback signal received from the voltage feedback connection with a predetermined target output voltage to determine if the predetermined target output voltage is being supplied; and
adjusting the current supplied by the power supply element if it is determined that the predetermined target input voltage is not being supplied.
